(19) United States
(12) Patent Application Publication
(10) Pub. No.: US 2026/0037828 A1
(43) Pub. Date: Feb. 5, 2026

(54) METHOD FOR PERFORMING FEDERATED LEARNING BASED ON MOE AND LORA, ELECTRONIC DEVICE SUPPORTING THE SAME, AND STORAGE MEDIUM

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Dongmin KIM, Suwon-si (KR); Seungho NA, Daejeon (KR); Youngjin JIN, Daejeon (KR); Jinwoo SHIN, Daejeon (KR); Bumhan KIM, Suwon-si (KR); Jungha PAIK, Suwon-si (KR); Seungwon SHIN, Suwon-si (KR); Hosuk CHOI, Suwon-si (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/291,296

(22) Filed: Aug. 5, 2025

Related U.S. Application Data
(63) Continuation of application No. PCT/KR2025/011497, filed on Aug. 1, 2025.

(30) Foreign Application Priority Data
Aug. 5, 2024 (KR) 10-2024-0104106
Jan. 20, 2025 (KR) 10-2025-0008340

(51) Int. Cl. G06N 3/098; G06F 40/40; G06N 3/0475

(52) U.S. Cl. CPC G06N 3/098; G06F 40/40; G06N 3/0475

(57) ABSTRACT

According to an embodiment, an electronic device may include communication circuitry; at least one processor including processing circuitry; and memory storing instructions that, when executed by the at least one processor individually or collectively, cause the electronic device to: identify a plurality of expert models corresponding to a plurality of external electronic devices, in a large language model, wherein the plurality of external electronic devices is configured to perform federated learning, and the large language model includes a gating network and the plurality of expert models, and transmit, to the plurality of external electronic devices, through the communication circuitry, an expert model corresponding to the gating network and a corresponding external electronic device.

### CROSS-REFERENCE TO RELATED APPLICATIONS

This application is a continuation of International Application No. PCT/KR2025/011497 designating the United States, filed on Aug. 1, 2025, in the Korean Intellectual Property Receiving Office, which claims priority to Korean Patent Application No. 10-2024-0104106, filed on Aug. 5, 2024, and Korean Patent Application No. 10-2025-0008340, filed on Jan. 20, 2025, in the Korean Intellectual Property Office, the disclosures of which are incorporated by reference herein in their entireties.

### BACKGROUND

### 1. Field

The disclosure relates to a method for performing federated learning based on mixture-of-experts (MoE) and low-rank adaptation (LoRA), an electronic device supporting the same, and a storage medium.

### 2. Description of Related Art

Portable digital communication devices have become an essential element of daily life for most people. Consumers desire to receive a variety of high-quality services using portable digital communication devices anytime, anywhere.

Portable digital communication devices store and process various pieces of personal information. Along with the widespread adoption of portable digital communication devices, the importance of protecting collected personal information has emerged. Federated learning is a scheme of training an artificial intelligence (AI) model with distributed data, while protecting data privacy.

The above information is presented as related art only to assist with an understanding of the disclosure. No determination has been made, and no assertion is made, as to whether any of the above might be applicable as prior art with regard to the disclosure.

### SUMMARY

According to an aspect of the disclosure, an electronic device includes: communication circuitry; at least one processor including processing circuitry; and memory storing instructions that, when executed by the at least one processor individually or collectively, cause the electronic device to: identify a plurality of expert models corresponding to a plurality of external electronic devices, in a large language model, wherein the plurality of external electronic devices is configured to perform federated learning, and the large language model includes a gating network and the plurality of expert models, and transmit, to the plurality of external electronic devices, through the communication circuitry, an expert model corresponding to the gating network and a corresponding external electronic device.

According to an aspect of the disclosure, a method of performing federated learning by an electronic device, includes: identifying a plurality of expert models corresponding to a plurality of external electronic devices, in a large language model, wherein the plurality of external electronic devices is configured to perform federated learning, and the large language model includes a gating network and the plurality of expert models; and transmitting, to each of the plurality of external electronic devices, an expert model corresponding to the gating network and a corresponding external electronic device.

According to an aspect of the disclosure, a non-transitory computer-readable storage medium storing computer-executable instructions that, when executed by at least one processor individually or collectively, cause an electronic device to: identify a plurality of expert models corresponding to a plurality of external electronic devices, in a large language model, wherein the plurality of external electronic devices is configured to perform federated learning, and the large language model includes a gating network and the plurality of expert models, and transmit, to each of the plurality of external electronic devices, an expert model corresponding to the gating network and a corresponding external electronic device

According to an aspect of the disclosure, an electronic device comprising, communication circuitry, at least one processor comprising processing circuitry, and memory storing instructions that, when executed by the at least one processor individually or collectively, cause the electronic device to, identify a plurality of expert models corresponding to a plurality of external electronic devices configured to perform federated learning, wherein the plurality of expert models are included in a large language model (LLM), and wherein the LLM includes a gating network pre-trained to identify at least one expert model, corresponding to input data, among the plurality of expert models, and transmit, to the plurality of external electronic devices, through the communication circuitry, the gating network and each of the plurality of expert models, for training the gating network and the each of the plurality of expert models.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to various embodiments of the disclosure;

FIG. 2 is a diagram illustrating an exemplary configuration of an electronic device in a network environment according to an embodiment of the disclosure;

FIG. 3 is a diagram illustrating a communication method between an electronic device and an external electronic device in a network environment according to an embodiment of the disclosure;

FIG. 4 is a flowchart illustrating a method for transmitting a gating network and an expert model corresponding to an external electronic device by an electronic device according to an embodiment of the disclosure;

FIG. 5 is a diagram illustrating a method for reducing communication costs with an external electronic device by an electronic device according to an embodiment of the disclosure;

FIGS. 6A, 6B, and 6C are diagrams illustrating a method for training some parameters of a large language model by an electronic device according to an embodiment of the disclosure;

FIG. 7 is a flowchart illustrating a method for obtaining an updated gating network and updated expert models by an electronic device according to an embodiment of the disclosure;

FIGS. 8A and 8B are diagrams illustrating a method for obtaining an updated gating network and updated expert models by an electronic device according to an embodiment of the disclosure;

FIG. 9 is a flowchart illustrating a method for distributing an updated gating network and updated expert models to a plurality of external electronic devices by an electronic device according to an embodiment of the disclosure; and

FIG. 10 is a diagram illustrating a generative artificial intelligence model according to an embodiment.

### DETAILED DESCRIPTION

Embodiments of the disclosure will be described below in detail with reference to the accompanying drawings so that those of ordinary skill in the art may easily practice the disclosure. However, the disclosure may be implemented in many different forms and should not be construed as limited to the embodiments set forth herein. In the description of the drawings, the same or similar reference numerals may be used for the same or similar components. Further, a description of well-known functions and configurations will be avoided in the drawings and related description, for clarity and conciseness.

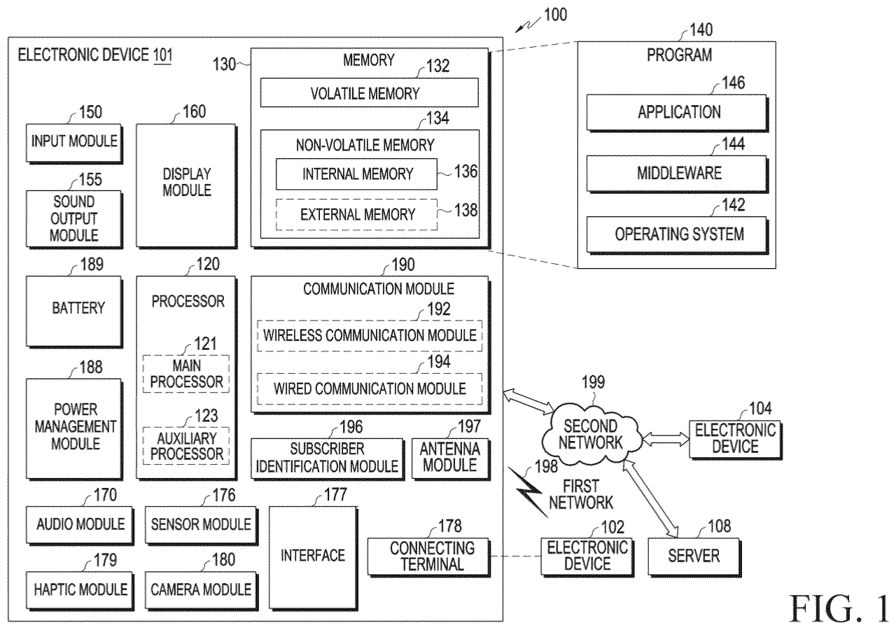

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

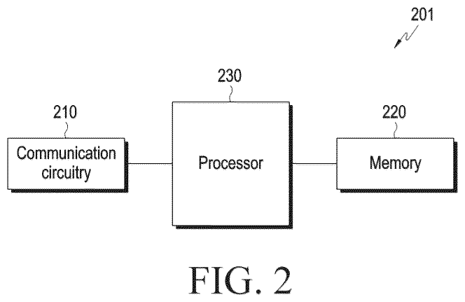

FIG. 2 is a diagram illustrating an exemplary configuration of an electronic device in a network environment according to an embodiment of the disclosure.

Referring to FIG. 2, in an embodiment, an electronic device 201 (e.g., the electronic device 101 or the server 108 of FIG. 1) may include communication circuitry 210, memory 220, and a processor 230. The electronic device 201 may be implemented as, but is not limited to, a server for performing federated learning.

In an embodiment, the communication circuitry 210 may provide functions corresponding to the communication module 190 of FIG. 1. In an embodiment, the communication circuitry 210 may communicate with an external electronic device via a network (e.g., the second network 199 of FIG. 1). The external electronic device may be, for example, a client device that trains an AI model (or some of the parameters of the AI model stored in the external electronic device) based on collecting personalized data. The AI model may include a generative AI model trained to output a response corresponding to a user utterance, based on receiving the user utterance or an input prompt corresponding to the user utterance. The AI model may also include a transformer-based AI model. The generative AI model may include a large language model (LLM) trained to output text information, an image generation model trained to output image information, or an LLM/retrieval-augmented generation (RAG) model trained to generate output information based on a search database. The image generation model may be implemented as a generative adversarial network (GAN), a variational autoencoder (VAE), or a diffusion model.

In an embodiment, the memory 220 may provide functions corresponding to the memory 130 of FIG. 1. In an embodiment, the memory 220 may store an AI model. In an embodiment, the AI model stored in the memory 220 may correspond to an AI model stored in each of a plurality of external electronic devices (or client devices) participating in federated learning from the electronic device 201 (e.g., server). The number of parameters of the AI model stored in each of the plurality of external electronic devices may be smaller than the number of parameters of the AI model stored in the memory 220.

In an embodiment, the processor 230 may provide functions corresponding to the processor 120 of FIG. 1.

In an embodiment, the number of processors 230 may be one or more. For example, the processor 230 may have a multi-core processor structure such as dual core, quad core, or hexa core.

In an embodiment, the processor 230 may control operations of the electronic device 101 by executing instructions stored in the memory 220. For example, the processor 230 may correspond to a plurality of processors that collectively perform a plurality of operations by dividing them among the processors.

In an embodiment, the processor 230 may control an overall operation for updating (e.g., changing parameters or weights) an AI model (or some parameters of the AI model) based on parameters received from each of the plurality of external electronic devices, and transmitting (or distributing) the updated AI model to the plurality of external electronic devices. In an embodiment, the processor 230 may include one or more processors for distributing the updated AI model to the plurality of external electronic devices. An operation performed by the processor 230 to obtain an updated AI model based on AI models trained by the plurality of external electronic devices based on an initial AI model will be described later.

The electronic device 201 is shown in FIG. 2 as including the communication circuitry 210, the memory 220, and/or the processor 230 by way of example, to which the disclosure is not limited. For example, the electronic device 201 may further include a component providing functions corresponding to at least one component illustrated in FIG. 1.

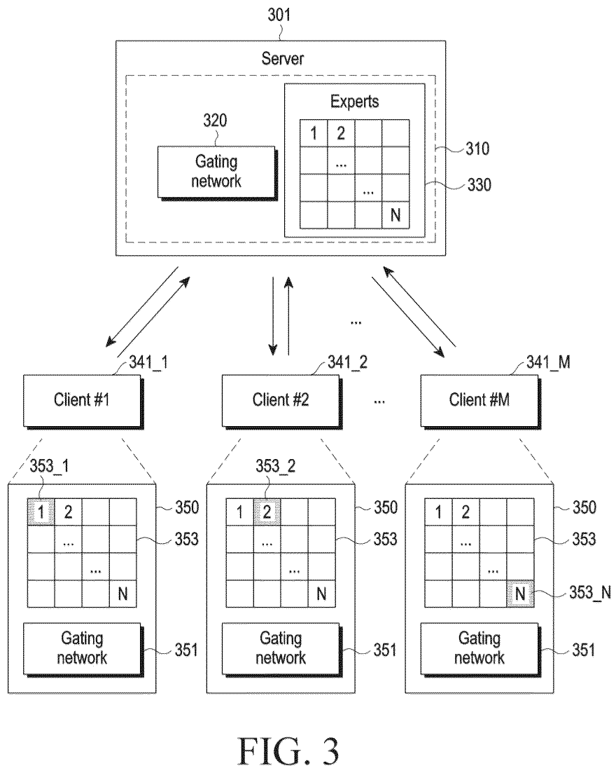

FIG. 3 is a diagram illustrating a communication method between an electronic device and an external electronic device in a network environment according to an embodiment of the disclosure.

In an embodiment, a server 301 may perform federated learning based on communicating with a plurality of external electronic devices 341_1, 341_2, to 341_M. Federated learning may be a method in which a model (e.g., a generative AI model) is trained in electronic devices (or “clients”) storing local data, and a server updates the model based on collecting model training results (or updated parameters). Updating the model may include changing at least some of parameters included in the model. In federated learning, data privacy may be protected because local data is not transmitted to the server but is used only for model training on the clients. The server 301 may include an LLM 310. The LLM 310 may include a gating network 320 and a plurality of expert models 330, based on mixture-of-experts (MoE). The LLM 310 may perform learning using some parameters without activating vast parameters. The gating network 320 may be trained to identify (or control traffic) at least one expert model, among the plurality of expert models 330, to which input data is to be input, in response to input data (e.g., tokens). Each of the plurality of expert models 330 may include a plurality of parameters fewer than a plurality of parameters corresponding to the LLM 310.

In an embodiment, the server 301 may reduce communication costs between the server 301 and the external electronic devices (or client devices) by transmitting an expert model corresponding to each of the plurality of external electronic devices 341_1, 341_2, to 341_M, from among the plurality of expert models 330, to the external electronic device. For example, the server 301 may transmit a first expert model from among the plurality of expert models 330 to a first external electronic device 341_1 (or a first client). The server 301 may transmit the gating network 320 along with the first expert model to the first external electronic device 341_1. The server 301 may transmit a second expert model from among the plurality of expert models 330 to a second external electronic device 341_2 (or a second client). The server 301 may transmit the gating network 320 along with the second expert model to the second external electronic device 341_2. The server 301 may transmit an Nth expert model from among the plurality of expert models 330 to an Mth external electronic device 341_M (or an Mth client). The server 301 may transmit the gating network 320 along with the Nth expert model to the Mth external electronic device 341_M. In an embodiment, the number (e.g., N) of the plurality of expert models 330 may be different from the number (e.g., M) of the plurality of external electronic devices 341_1, 341_2, to 341_M. In an embodiment, the number (e.g., N) of the plurality of expert models 330 may be equal to the number (e.g., M) of the plurality of external electronic devices 341_1, 341_2, to 341_M. In an embodiment, each of the models (or networks) transmitted between the server 301 and the plurality of external electronic devices 341_1, 341_2, to 341_M may include a plurality of parameters.

In an embodiment, each of the plurality of external electronic devices 341_1, 341_2, to 341_M may store an LLM 350. The LLM 350 may include a gating network 351 and a plurality of expert models 353. Each of the plurality of external electronic devices 341_1, 341_2, to 341_M may perform local learning based on the expert model and the gating network 320 received from the server 301. Each of the plurality of external electronic devices 341_1, 341_2, to 341_M may train the gating network 351 and the received expert model from among the plurality of expert models 353, using local data (e.g., “privacy data” or “user data”) obtained by the external electronic device. For example, the first external electronic device 341_1 may train the gating network 351 and a first expert model 353_1 from among the plurality of expert models 353 stored in the first external electronic device 341_1, using local data obtained by the first external electronic device 341_1. The second external electronic device 341_2 may train the gating network 351 and a second expert model 353_2 from among the plurality of expert models 353 stored in the second external electronic device 341_2, using local data obtained by the second external electronic device 341_2. The Mth external electronic device 341_M may train the gating network 351 and an Mth expert model 353_M from among the plurality of expert models 353 stored in the Mth external electronic device 341_M, using local data obtained by the Mth external electronic device 341_M.

In an embodiment, each of the plurality of external electronic devices 341_1, 341_2, to 341_M may transmit the expert model trained using the local data and the gating network trained using the local data to the server 301. For example, the first external electronic device 341_1 may transmit the first expert model trained using the local data obtained by the first external electronic device 341_1 and the gating network trained using the local data obtained by the first external electronic device 341_1 to the server 301. The second external electronic device 341_2 may transmit the second expert model trained using the local data obtained by the second external electronic device 341_2 and the gating network trained using the local data obtained by the second external electronic device 341_2 to the server 301. The Mth external electronic device 341_M may transmit the Nth expert model trained using the local data obtained by the Mth external electronic device 341_M and the gating network trained using the local data obtained by the Mth external electronic device 341_M to the server 301.

In an embodiment, the server 301 may obtain updated expert models and an updated gating network based on the plurality of expert models and the plurality of gating networks received from the plurality of external electronic devices 341_1, 341_2, to 341_M. The server 301 may perform parameter-efficient training by separating the training of the plurality of expert models from the training of the gating network. The server 301 may train an expert model corresponding to an expert model received from an external electronic device, from among the plurality of expert models 330 stored in the server 301, based on the plurality of expert models received from the plurality of external electronic devices 341_1, 341_2, to 341_M. For example, the server 301 may train the first expert model corresponding to the expert model trained based on the local data of the first external electronic device 341_1, based on the trained expert model received from the first external electronic device 341_1. The server 301 may obtain an updated expert model based on training the first expert model. The server 301 may train the second expert model corresponding to the expert model trained based on the local data of the second external electronic device 341_2, based on the trained expert model received from the second external electronic device 341_2. The server 301 may obtain an updated expert model based on training the second expert model. The server 301 may train the Nth expert model corresponding to the expert model trained based on the local data of the Mth external electronic device 341_M, based on the trained expert model received from the Mth external electronic device 341_M. The server 301 may obtain an updated expert model based on training the Nth expert model. The server 301 may train the gating network 320 stored in the server 301, based on the plurality of gating networks received from the plurality of external electronic devices 341_1, 341_2, to 341_M. The server 301 may obtain an updated gating network based on the gating network trained based on the local data obtained by the first external electronic device 341_1, the gating network trained based on the local data obtained by the second external electronic device 341_2, and up to the gating network trained based on the local data obtained by the Mth external electronic device 341_M. In an embodiment, the sequential operations in which the server 301 distributes the gating network 320 and the expert models corresponding to the external electronic devices among the plurality of expert models 330 to the plurality of external electronic devices 341_1, 341_2, to 341_M, receives a plurality of trained gating networks and a plurality of trained expert models from the plurality of external electronic devices 341_1, 341_2, to 341_M, and obtains an updated gating network and a plurality of updated expert models, may be referred to as a “round.” The server 301 may distribute an Rth updated gating network and a plurality of Rth updated expert models to the plurality of external electronic devices 341_1, 341_2, to 341_M, based on repeating a plurality of rounds (e.g., R rounds).

In an embodiment, methods for reducing the computing cost of an LLM (e.g., generalist language model (GLaM) or mixture of language experts (MoLE)) may be unsuitable for application to federated learning. For example, GLAM may increase communication costs between a server and a client due to inclusion of parameters in the order of trillions. MoLE may be unsuitable for federated learning that requires training of a gating network and a plurality of expert models, due to requirement of the premise that a plurality of expert models have already been trained.

In an embodiment, the server 301 may perform parameter-efficient training and reduce communication costs between the server and clients based on a federated LoRA (FLORA) method.

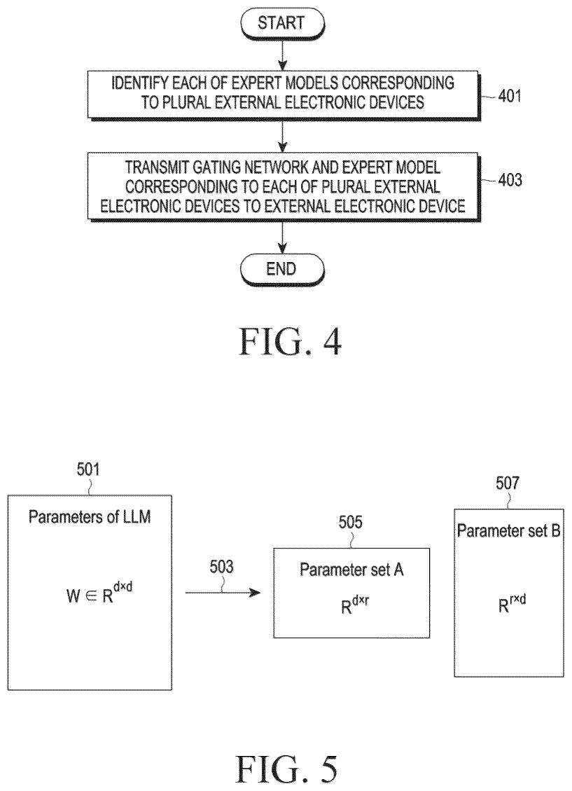

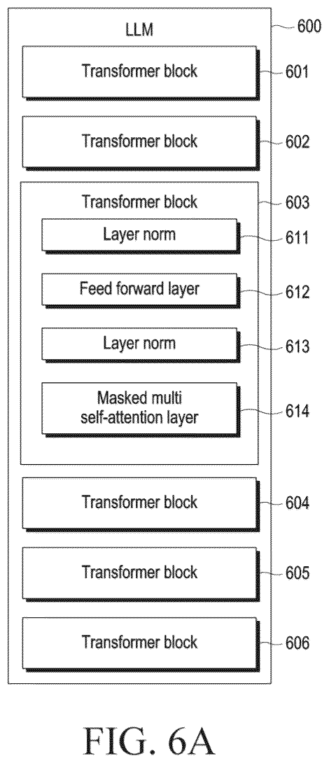

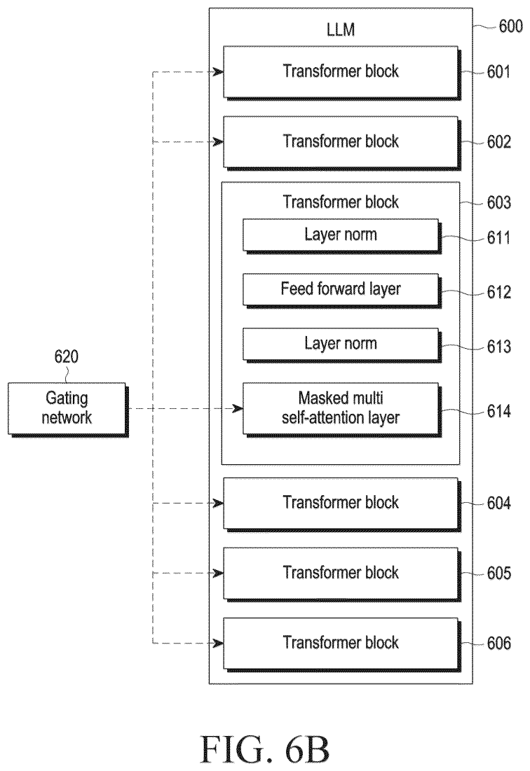

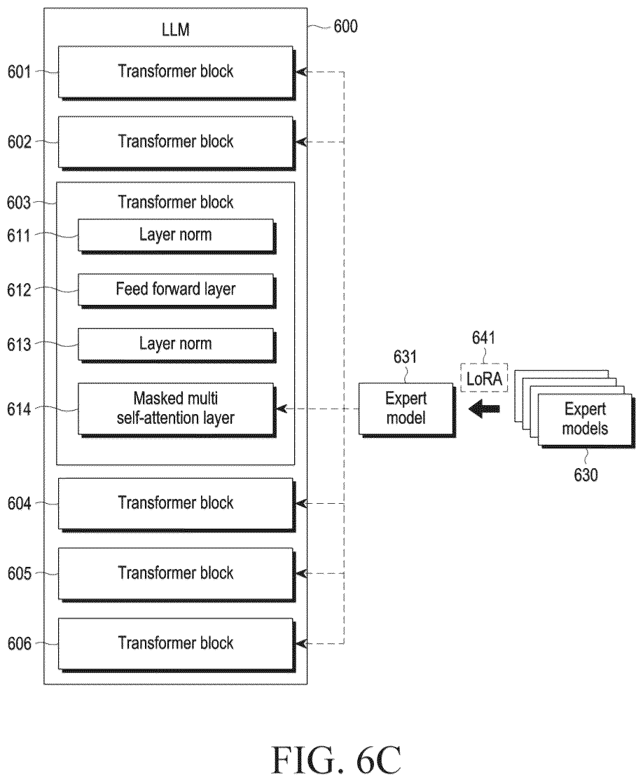

FIG. 4 is a flowchart illustrating a method for transmitting a gating network and an expert model corresponding to an external electronic device by an electronic device according to an embodiment of the disclosure. The embodiment of FIG. 4 will be described with reference to FIGS. 5, 6A, 6B, and 6C. FIG. 5 is a diagram illustrating a method for reducing communication costs with an external electronic device by an electronic device according to an embodiment of the disclosure. FIGS. 6A, 6B, and 6C are diagrams illustrating a method for training some parameters of an LLM by an electronic device according to an embodiment of the disclosure.

In an embodiment, the operations illustrated in FIG. 4 are not limited to the illustrated order and may be performed in various orders. For example, the order of the operation may be changed, and at least two operations may be performed in parallel. According to an embodiment, more operations than those illustrated in FIG. 4 may be performed, or at least one operation fewer than those illustrated in FIG. 4 may be performed.

Referring to FIG. 4, in operation 401, in an embodiment, the electronic device 201 (e.g., the processor 230 and/or the server 301) may identify, in an LLM, a plurality of expert models respectively corresponding to a plurality of external electronic devices (e.g., the plurality of external electronic devices 341_1, 341_2, to 341_M) that perform federated learning. The LLM (e.g., the LLM 310) may include a gating network (e.g., the gating network 320) and a plurality of expert models (e.g., the plurality of expert models 330). In an embodiment, expert-client mapping may be performed randomly. Based on a plurality of rounds of federated learning being performed, expert-client mapping may be optimized based on a linear sum assignment (LSA) algorithm.

Referring to FIG. 5, in an embodiment, each of the plurality of expert models may include a plurality of parameters R^{d×r} obtained based on low-rank adaptation (LoRA) from among a plurality of parameters R^{d×d} of the LLM. LoRA may be a technique for fine-tuning a pre-trained language model (PLM). The parameters of the PLM may be represented as a weight matrix W. Each of the number of rows and the number of columns of the weight matrix W may be d. A d*d matrix set R may be expressed as R^{d×d}. Based on the sparsity of gradients updated during the fine-tuning of the PLM, the electronic device 201 may perform fine-tuning using a small number of parameters included in a specific portion (attention weights) of the LLM. For example, the electronic device 201 may obtain parameter sets 505 and 507 corresponding to low-rank matrices, based on performing matrix decomposition 503 for gradients, from among the entire parameters 501 of the LLM. For example, a matrix set of parameter set A 505 decomposed by rank r may be expressed as R^{d×r}. A matrix set of parameter set B 507 decomposed by rank r may be expressed as R^{r×d}. The electronic device 201 (or client) may perform parameter-efficient training based on learning the obtained parameter sets 505 and 507.

Referring to FIG. 6A, in an embodiment, an LLM 600 may include a plurality of transformer blocks 601, 602, 603, 604, 605, and 606. Each of the plurality of transformer blocks 601, 602, 603, 604, 605, and 606 may include layer norms (LNs) 611 and 613, a feed forward layer 612, and a masked multi self-attention layer 614. The structure of the transformer block is not limited to the above example. In an embodiment, parameters of the LLM 600 may be in a frozen state. The electronic device 201 may fine-tune the LLM 600 using a small amount of training data, without substantially changing the structure of the LLM 600, based on a parameter set for fine-tuning obtained based on matrix decomposition. In an embodiment, the LLM 600 may include a text input prediction model trained to predict text information to be input sequentially, based on input text information. The text input prediction model may be trained at a client end based on training data (e.g., local data) including information related to a typing pattern, a language usage pattern, and communication preference of a user.

Referring to FIG. 6B, in an embodiment, a gating network 620 may be updated by learning parameters of the masked multi self-attention layer 614 included in each of the transformer blocks 601, 602, 603, 604, 605, and 606. Each of the plurality of transformer blocks 601, 602, 603, 604, 605, and 606 may include the gating network 620 and a plurality of expert models. The updating of the gating network 620 may be separated from the updating of the plurality of expert models.

Referring to FIG. 6C, in an embodiment, a plurality of expert models 630 may be updated by learning parameters of the masked multi self-attention layer 614 included in each of the transformer blocks 601, 602, 603, 604, 605, and 606. A small number of parameters (e.g., parameters corresponding to the gating network and the plurality of expert models 630) decomposed by LoRA in each of the plurality of transformer blocks 601, 602, 603, 604, 605, and 606 may be updated based on parameter-efficient fine-tuning. The electronic device 201 may selectively train an expert model 631 corresponding to an expert model trained by an external electronic device, from among the plurality of expert models included in the transformer block. Herein, the expert model 631 may be an expert model obtained 641 based on LoRA. The operation of updating the expert model 631 corresponding to a client (or “external electronic device”) among the expert models 631 may include updating (or changing) parameters obtained based on LoRA. Since the number of parameters obtained based on LoRA is much smaller than the number of parameters of a PLM, parameter-efficient fine-tuning may be performed.

In operation 403, in an embodiment, the electronic device 201 may transmit the gating network and an expert model corresponding to each of the plurality of external electronic devices to the external electronic device through communication circuitry (e.g., the communication circuitry 210). The external electronic device may be included in the plurality of external electronic devices. The expert model may be included in the plurality of expert models. The electronic device 201 may reduce communication costs between the electronic device 201 and the external electronic device by transmitting the gating network and the expert model corresponding to the external electronic device from among the plurality of expert models, without transmitting the entire parameters of the PLM.

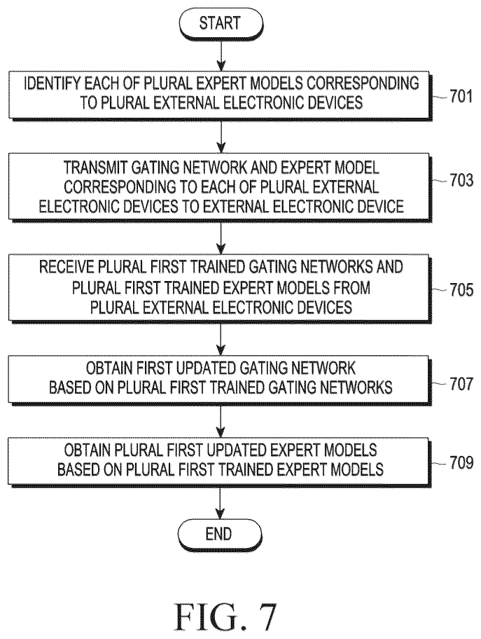

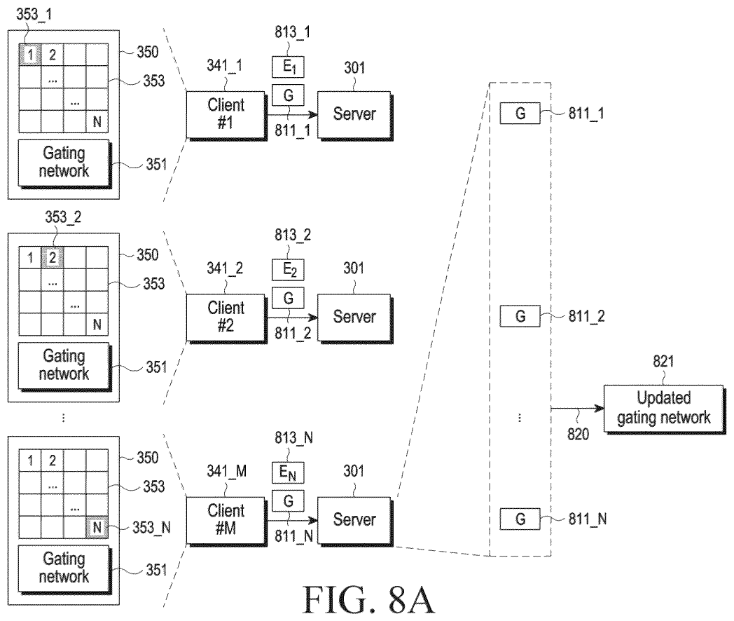

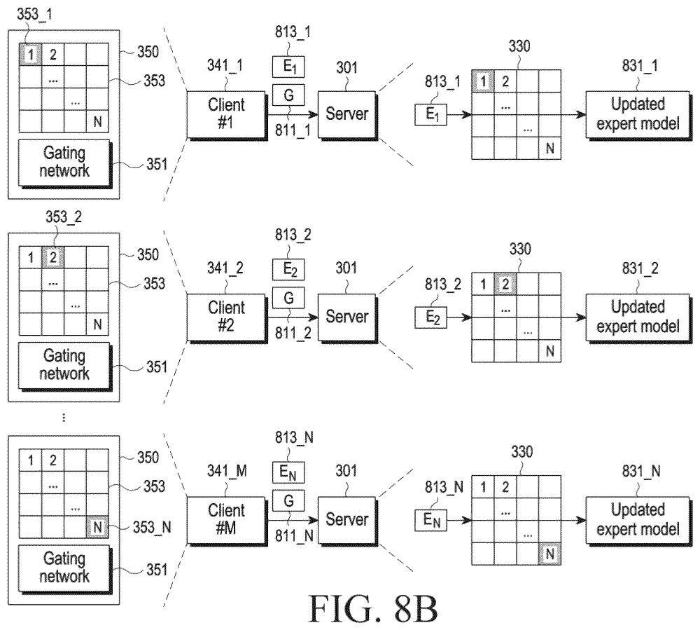

FIG. 7 is a flowchart illustrating a method for obtaining an updated gating network and updated expert models by an electronic device according to an embodiment of the disclosure. The embodiment of FIG. 7 will be described with reference to FIGS. 8A and 8B. FIGS. 8A and 8B are diagrams illustrating a method for obtaining an updated gating network and updated expert models by an electronic device according to an embodiment of the disclosure.

In an embodiment, the operations illustrated in FIG. 7 are not limited to the illustrated order and may be performed in various orders. For example, the order of the operations may be changed, and at least two operations may be performed in parallel. According to an embodiment, more operations than those illustrated in FIG. 7 may be performed, or at least one operation fewer than those illustrated in FIG. 7 may be performed.

Referring to FIG. 7, in operation 701, in an embodiment, the electronic device 201 (e.g., the processor 230 and/or the server 301) may identify a plurality of expert models respectively corresponding to a plurality of external electronic devices (e.g., the plurality of external electronic devices 341_1, 341_2, to 341_M). In an embodiment, operation 701 may be at least partially identical or similar to operation 401, and a redundant description with operation 401 may be avoided herein.

In operation 703, in an embodiment, the electronic device 201 may transmit a gating network and an expert model corresponding to each of the plurality of external electronic devices to the external electronic device through communication circuitry (e.g., the communication circuitry 210). In an embodiment, operation 703 may be at least partially identical or similar to operation 403, and a redundant description with operation 403 may be avoided herein.

In operation 705, in an embodiment, the electronic device 201 may receive a plurality of first trained gating networks and a plurality of first trained expert models from the plurality of external electronic devices through the communication circuitry. Each of the plurality of first trained gating networks may include a plurality of parameters changed based on a plurality of parameters of the gating network and first training data of the external electronic device. The first training data of the external electronic device may include user data obtained by the external electronic device. Each of the plurality of first trained expert models may include a plurality of parameters changed based on a plurality of parameters of the expert model corresponding to the external electronic device and the first training data of the external electronic device.

In operation 707, in an embodiment, the electronic device 201 may obtain a first updated gating network by changing the plurality of parameters of the gating network based on the plurality of first trained gating networks.

Referring to FIG. 8A, in an embodiment, the first external electronic device 341_1 may obtain a trained gating network 811_1 and a trained expert model 813_1, based on training the gating network 351 and the first expert model 353_1 using local data obtained by the first external electronic device 341_1. The gating network may include a relatively small number of parameters based on LoRA. The training of the gating network may be performed according to Equation 1 for data x, gating network parameters θ_{G}, and a pre-trained LLM θ_{baze}. A label l required for training the gating network may be defined by expert-client mapping.

$${min}_{θ} \frac{1}{N} {\sum }_{k = 1}^{N} L ( {θ}_{base} + Δ {θ}_{G} , x , l ) \qquad [ Equation 1 ]$$

Equation 1 above is merely an example for helping understanding, to which embodiments of the disclosure may not be limited. For example, Equation 1 may be modified, applied, or extended in various ways.

The first external electronic device 341_1 may transmit the trained gating network 811_1 and the trained expert model 813_1 to the server 301. The second external electronic device 341_2 may obtain a trained gating network 811_2 and a trained expert model 813_2, based on training the gating network 351 and the second expert model 353_2 using local data obtained by the second external electronic device 341_2. The second external electronic device 341_2 may transmit the trained gating network 811_2 and the trained expert model 813_2 to the server 301. The Mth external electronic device 341_M may obtain a trained gating network 811_N and a trained expert model 813_N, based on training the gating network 351 and the Nth expert model 353_N using local data obtained by the Mth external electronic device 341_M. The Mth external electronic device 341_M may transmit the trained gating network 811_N and the trained expert model 813_N to the server 301. The server 301 may obtain an updated gating network 821 by changing 820 the plurality of parameters of the gating network, based on the plurality of trained gating networks 811_1, 811_2, to 811_N received from the plurality of external electronic devices 341_1, 341_2, to 341_M.

In operation 709, in an embodiment, the electronic device 201 may obtain a plurality of first updated expert models by changing a plurality of parameters of an expert model corresponding to each of the plurality of first trained expert models, based on the plurality of first trained expert models.

Referring to FIG. 8B, in an embodiment, the server 301 may obtain a plurality of updated expert models 831_1, 831_2, to 831_N by changing a plurality of parameters of an expert model corresponding to each of the plurality of trained expert models 813_1, 813_2, to 813_N, from among the plurality of expert models 330, based on the plurality of trained expert models 813_1, 813_2, to 813_N received from the plurality of external electronic devices 341_1, 341_2, to 341_M. For local data (x, y) of client M, expert parameters Δθ_{E}^{m} may be trained according to Equation 2.

$${min}_{{θ}_{E}^{m}} L ( {θ}_{b a s e} + {Δθ}_{E}^{m} , x , y ) \qquad [ Equation 2 ]$$

Equation 2 above is merely an example for helping understanding, to which embodiments of the disclosure may not be limited. For example, Equation 1 may be modified, applied, or extended in various ways.

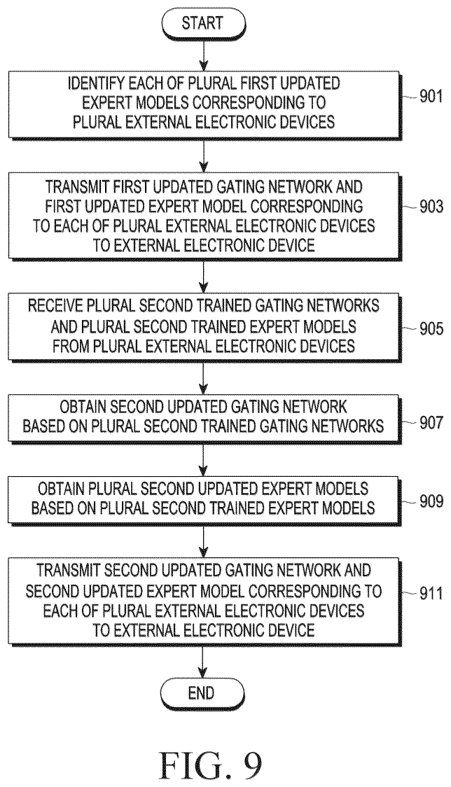

FIG. 9 is a flowchart illustrating a method for distributing an updated gating network and updated expert models to a plurality of external electronic devices by an electronic device according to an embodiment of the disclosure.

In an embodiment, the operations illustrated in FIG. 9 are not limited to the illustrated order and may be performed in various orders. For example, the order of the operations may be changed, and at least two operations may be performed in parallel. According to an embodiment, more operations than those shown in FIG. 9 may be performed, or at least one operation fewer than those shown in FIG. 9 may be performed.

Referring to FIG. 9, in operation 901, in an embodiment, the electronic device 201 (e.g., the processor 230 and/or the server 301) may identify, in an LLM, a plurality of first updated expert models respectively corresponding to a plurality of external electronic devices (e.g., the plurality of external electronic devices 341_1, 341_2, to 341_M). The LLM may include a first updated gating network and the plurality of first updated expert models. In an embodiment, the electronic device 201 may identify the plurality of first updated expert models respectively corresponding to the plurality of external electronic devices, based on an LSA method.

In operation 903, in an embodiment, the electronic device 201 may transmit the first updated gating network and a first expert model corresponding to each of the plurality of external electronic devices to the external electronic device through communication circuitry (e.g., the communication circuitry 210). The first updated expert model may be included in the plurality of first updated expert models. The external electronic device may be included in the plurality of external electronic devices.

In operation 905, in an embodiment, the electronic device 201 may receive a plurality of second trained gating networks and a plurality of second trained expert models from the plurality of external electronic devices through the communication circuitry. Each of the plurality of second trained gating networks may include a plurality of parameters changed based on a plurality of parameters of the first updated gating network and second training data of the external electronic device. The second training data of the external electronic device may include user data obtained by the external electronic device. Each of the plurality of second trained expert models may include a plurality of parameters changed based on a plurality of parameters of the first updated expert model corresponding to the external electronic device and the second training data of the external electronic device.

In operation 907, in an embodiment, the electronic device 201 may obtain a second updated gating network by changing the plurality of parameters of the first updated gating network, based on the plurality of second trained gating networks.

In operation 909, in an embodiment, the electronic device 201 may obtain a plurality of second updated expert models by changing a plurality of parameters of a first updated expert model corresponding to each of the plurality of second trained expert models, based on the plurality of second trained expert models.

In operation 911, in an embodiment, the electronic device 201 may transmit the second updated gating network and a second updated expert model corresponding to each of the plurality of external electronic devices to the external electronic device through the communication circuitry. The second updated expert model may be included in the plurality of second updated expert models.

In an embodiment, the electronic device 201 may reduce costs incurred in communication with the plurality of external electronic devices by transmitting and/or receiving a much smaller number of parameters than a PLM, based on the MoE concept and the FLoRA method. Referring to Table 1, the number of communication parameters per round required by each client may be significantly smaller than the total number of parameters of the PLM.

TABLE 1

| | Communication | |
|---|---|---|
| | cost (number of | Number |
| | communication | of training |
| Model type | parameters) | parameters |
| DistilGPT2 + Classifier | 82M | 82M |
| DistilGPT2 + MoE + Classifier | 23M | 23M |
| DistilGPT2 + LoRA + Classifier | 148K | 148K |
| FLoRA | 148K (Gating) + | 148K * expert |
| | 148K (Expert) | count + 148K |

Table 1 may show that when federated learning is performed based on the FLoRA method, a much smaller number of parameters (e.g., less than 200,000) than the number of parameters (e.g., tens of millions of parameters) of the PLM are transmitted between the server and a client. Referring to Table 1, the number (e.g., hundreds of thousands to millions) of parameters trained within the client may be much smaller than the number of parameters (e.g., tens of millions of parameters) of the PLM. In the disclosure, when federated learning is performed based on the FLORA method, communication costs between the server and the client and training costs of the client may be significantly reduced.

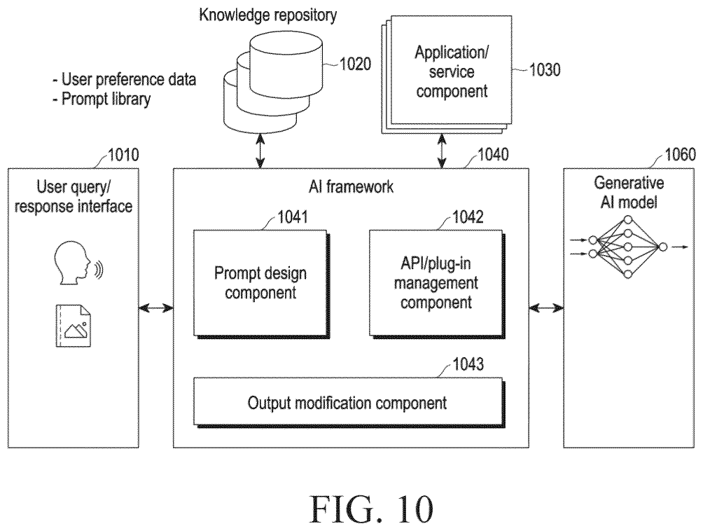

FIG. 10 is a diagram illustrating a generative artificial intelligence (AI) model according to an embodiment.

Referring to FIG. 10, a user query/response interface 1010, an application/service component 1030, a knowledge repository 1020, an AI framework 1040, and a generative AI model 1060 may be stored in memory (e.g., the memory 130 of FIG. 1) or in a separate server. At least some of the user query/response interface 1010, the application/service component 1030, the knowledge repository 1020, the AI framework 1040, or the generative AI model 1060 may be implemented in software or hardware.

According to an embodiment, the user query/response interface 1010 may receive a user input. The user input may be in the form of a natural language, an image, and/or a video, to which the user input is not limited. Additionally, context information may also be transmitted along with the transmission of the user input. The context information may include various pieces of additional information at the time of the user input. For example, the additional information may include information about an application currently being used by the user or information about the location of the user. Further, the user input may also be in the form of a combination of the above-described natural language, image, sound, and context information. Additionally, the user input may also be in a non-natural language form, such as selecting a menu. The user query/response interface 1010 may output results of the generative AI system to the user. The output may be in the form of a natural language or specific content, and may also be provided in a form such as an action requested by the user. The user query/response interface 1010 may output results of the generative AI system to the user. The output may be in the form of a natural language or specific content, and may also be provided in a form such as an action requested by the user.

The AI framework 1040 may receive the user input and coordinate and control each component necessary to perform the user's intention based on a user's query.

The user input received from the user query/response interface 1010 may be transmitted to a prompt design component 1041. The prompt design component 1041 may be used to generate a prompt suitable for inputting the user input into an LLM, a large vision model (LVM), or a large multimodal model (LMM). The prompt design component 1041 may be an AI component that uses a machine learning algorithm or a neural network to develop better prompts over time. The prompt design component 1041 may generate a prompt by accessing a knowledge component including user preference data, a prompt library, and prompt examples based on a user input, and transmit the generated prompt to the LLM or LMM.

An API/Plug-in management component 1042 may function to communicate with external information, in the presence of a request for additional information when transmitting the user input as an input to a generative model. The API/Plug-in management component 1042 may establish a channel for communicating with the outside of the AI interface via an API and enable access to various data sources (e.g., the knowledge repository 1020) through the established channel. Additionally, when an action for finally performing a user input, rather than an intermediate result, needs to be performed in an application or service, the API/Plug-in management component 1042 may request the corresponding action from the application/service component 1030 via the API. Information obtained from the outside may be used by the prompt design component 1041 to generate a prompt along with the user input, or may be transmitted as an input to the generative model.

An output modification component (also referred to as a refiner component) 1043 may fine-tune results output from the generative model. For example, the output modification component 1043 may verify whether content generated through the LLM and/or LMM is irrelevant, contains biased content, or contains harmful content. Additionally, the output modification component 1043 may determine how closely the output matches the user's desired result, and when an additional process is required, it may proceed with that process. The output modification component 1043 may additionally configure and provide hints for avoiding an unwanted output to the user.

The generative AI model 1060 may generally refer to an AI neural network that generates a new form of data, relying on user input information. The generative AI model 1060 may include a model that generates an image and/or a model that generates a language. Models that generate images typically include GAN and VAE, and diffusion-based generative models using VAE and a transformer structure may be taken as an example. Models that generate a language are models trained to output a statistically most appropriate output value based on an input value, and their representative examples may include models such as CHAT-GPT 3 and CHAT-GPT 4. There are also LMMs that may recognize various forms of data inputs such as text, images, and audio, and generate new data corresponding to them.

According to an embodiment of the disclosure, an electronic device (e.g., the electronic device 201 of FIG. 2) may include communication circuitry (e.g., the communication circuitry 210 of FIG. 2), at least one processor (e.g., the processor 230 of FIG. 2) including processing circuitry, and memory (e.g., the memory 220 of FIG. 2) storing instructions. The instructions, when executed by the at least one processor 230 individually or collectively, may cause the electronic device 201 to identify a plurality of expert models respectively corresponding to a plurality of external electronic devices, in a large language model, configured to perform federated learning. The large language model may include a gating network and the plurality of expert models. The instructions, when executed by the at least one processor 230 individually or collectively, may cause the electronic device 201 to transmit, to each of the plurality of external electronic devices, through the communication circuitry 210, the gating network and a corresponding one of the plurality of expert models.

According to an embodiment, each of the plurality of expert models may include a plurality of parameters, and a number of the plurality of parameters may be smaller than a number of a plurality of parameters included in the large language model. The gating network may be trained to identify, in response to input data, at least one expert model, to which the input data is input, among the plurality of expert models. The instructions, when executed by the at least one processor 230 individually or collectively, may cause the electronic device 201 to receive, from the plurality of external electronic devices, through the communication circuitry 210, a plurality of first trained gating networks and a plurality of first trained expert models. The instructions, when executed by the at least one processor 230 individually or collectively, may cause the electronic device 201 to obtain a first updated gating network by changing a plurality of parameters of the gating network based on the plurality of first trained gating networks. The instructions, when executed by the at least one processor 230 individually or collectively, may cause the electronic device 201 to obtain a plurality of first updated expert models by changing a plurality of parameters of an expert model corresponding to each of the plurality of first trained expert models, respectively, based on the plurality of first trained expert models.

In an embodiment, each of the plurality of first trained gating networks may include a plurality of parameters changed based on the plurality of parameters of the gating network and first training data of the external electronic device. Each of the plurality of first trained expert models may include a plurality of parameters changed based on the plurality of parameters of the expert model corresponding to the external electronic device and the first training data of the external electronic device. The first training data of the external electronic device may include user data obtained by the external electronic device.

In an embodiment, the instructions, when executed by the at least one processor 230 individually or collectively, may cause the electronic device 201 to identify a plurality of first updated expert models respectively corresponding to the plurality of external electronic devices, in the large language model. The large language model may include the first updated gating network and the plurality of first updated expert models. The instructions, when executed by the at least one processor 230 individually or collectively, may cause the electronic device 201 to transmit, to each of the plurality of external electronic devices, through the communication circuitry (210), the first updated gating network and a corresponding one of the plurality of first updated expert models.

In an embodiment, the instructions, when executed by the at least one processor 230 individually or collectively, may cause the electronic device 201 to, based on a linear sum assignment (LSA) method, identify the plurality of first updated expert models respectively corresponding to the plurality of external electronic devices, in the large language model.

In an embodiment, the instructions, when executed by the at least one processor 230 individually or collectively, may cause the electronic device 201 to receive, from the plurality of external electronic devices, through the communication circuitry 210, a plurality of second trained gating networks and a plurality of second trained expert models. The instructions, when executed by the at least one processor 230 individually or collectively, may cause the electronic device 201 to obtain a second updated gating network by changing a plurality of parameters of the first updated gating network based on the plurality of second trained gating networks. The instructions, when executed by the at least one processor 230 individually or collectively, may cause the electronic device 201 to obtain a plurality of second updated expert models by changing a plurality of parameters of a first updated expert model corresponding to each of the plurality of second trained expert models based on the plurality of second trained expert models. The instructions, when executed by the at least one processor 230 individually or collectively, may cause the electronic device 201 to transmit, to each of the plurality of external electronic devices, through the communication circuitry (210), the second updated gating network and a corresponding one of the plurality of second updated expert models.

In an embodiment, each of the plurality of second trained gating networks may include a plurality of parameters changed based on the plurality of parameters of the first updated gating network and second training data of the external electronic device. Each of the plurality of second trained expert models may include a plurality of parameters changed based on the plurality of parameters of the first updated expert model corresponding to the external electronic device and the second training data of the external electronic device. The second training data of the external electronic device may include user data obtained by the external electronic device.

In an embodiment, the large language model may include a plurality of transformer blocks. Each of the transformer blocks may include the gating network and the plurality of expert models. Each of the plurality of expert models may include a plurality of parameters obtained based on LoRA (low-rank adaptation) among a plurality of parameters of the large language model.

In an embodiment, the large language model may include a text input estimation model trained to estimate text information to be sequentially input based on input text information. The text input estimation model may be trained based on training data including information associated with a typing pattern, a language usage pattern, and communication preference of a user.

According to an embodiment, a method may include identifying a plurality of expert models respectively corresponding to a plurality of external electronic devices, in a large language model, configured to perform federated learning. The large language model may include a gating network and the plurality of expert models. The method may include transmitting, to each of the plurality of external electronic devices, through communication circuitry of the electronic device, the gating network and a corresponding one of the plurality of expert models.

In an embodiment, each of the plurality of expert models may include a plurality of parameters, wherein a number of the plurality of parameters is smaller than a number of a plurality of parameters included in the large language model. The gating network may be trained to identify, in response to input data, at least one expert model, to which the input data is input, among the plurality of expert models. The method may further include receiving, from the plurality of external electronic devices, through the communication circuitry 210, a plurality of first trained gating networks and a plurality of first trained expert models. The method may further include obtaining a first updated gating network by changing a plurality of parameters of the gating network based on the plurality of first trained gating networks. The method may further include obtaining a plurality of first updated expert models by changing a plurality of parameters of an expert model corresponding to each of the plurality of first trained expert models, respectively, based on the plurality of first trained expert models.

In an embodiment, each of the plurality of first trained gating networks may include a plurality of parameters changed based on the plurality of parameters of the gating network and first training data of the external electronic device. Each of the plurality of first trained expert models may include a plurality of parameters changed based on the plurality of parameters of the expert model corresponding to the external electronic device and the first training data of the external electronic device. The first training data of the external electronic device may include user data obtained by the external electronic device.

In an embodiment, the method may further include identifying a plurality of first updated expert models respectively corresponding to the plurality of external electronic devices, in the large language model. The large language model may include the first updated gating network and the plurality of first updated expert models. The method may further include transmitting, to each of the plurality of external electronic devices, through the communication circuitry 210, the first updated gating network and a corresponding one of the plurality of first updated expert models.

In an embodiment, identifying the plurality of first updated expert models respectively corresponding to the plurality of external electronic devices, in the large language model may include, based on an LSA method, identifying the plurality of first updated expert models respectively corresponding to the plurality of external electronic devices, in the large language model.

In an embodiment, the method may further include receiving, from the plurality of external electronic devices, through the communication circuitry 210, a plurality of second trained gating networks and a plurality of second trained expert models. The method may further include obtaining a second updated gating network by changing a plurality of parameters of the first updated gating network based on the plurality of second trained gating networks. The method may further include obtaining a plurality of second updated expert models by changing a plurality of parameters of a first updated expert model corresponding to each of the plurality of second trained expert models based on the plurality of second trained expert models. The method may further include transmitting, to each of the plurality of external electronic devices, through the communication circuitry 210, the second updated gating network and a corresponding one of the plurality of second updated expert models.

In an embodiment, each of the plurality of second trained gating networks may include a plurality of parameters changed based on the plurality of parameters of the first updated gating network and second training data of the external electronic device. Each of the plurality of second trained expert models may include a plurality of parameters changed based on the plurality of parameters of the first updated expert model corresponding to the external electronic device and the second training data of the external electronic device. The second training data of the external electronic device may include user data obtained by the external electronic device.

In an embodiment, the large language model may include a plurality of transformer blocks. Each of the transformer blocks may include the gating network and the plurality of expert models. Each of the plurality of expert models may include a plurality of parameters obtained based on LoRA among a plurality of parameters of the large language model.

In an embodiment, the large language model may include a text input estimation model trained to estimate text information to be sequentially input based on input text information. The text input estimation model may be trained based on training data including information associated with a typing pattern, a language usage pattern, and communication preference of a user.

According to an embodiment of the disclosure, in a non-transitory computer-readable storage medium storing computer-executable instructions, the computer-executable instructions, when executed by at least one processor 230 individually or collectively, may cause an electronic device 201 to identify a plurality of expert models respectively corresponding to a plurality of external electronic devices, in a large language model, configured to perform federated learning. The large language model may include a gating network and the plurality of expert models. The computer-executable instructions, when executed by at least one processor 230 individually or collectively, may cause the electronic device 201 to transmit, to each of the plurality of external electronic devices, through communication circuitry 210 of the electronic device 201, the gating network and a corresponding one of the plurality of expert models.

In an embodiment, each of the plurality of expert models may include a plurality of parameters, and a number of the plurality of parameters may be smaller than a number of a plurality of parameters included in the large language model. The gating network may be trained to identify, in response to input data, at least one expert model, to which the input data is input, among the plurality of expert models. The computer-executable instructions, when executed by at least one processor 230 individually or collectively, may cause the electronic device 201 to receive, from the plurality of external electronic devices, through the communication circuitry 210, a plurality of first trained gating networks and a plurality of first trained expert models. The computer-executable instructions, when executed by at least one processor 230 individually or collectively, may cause the electronic device 201 to obtain a first updated gating network by changing a plurality of parameters of the gating network based on the plurality of first trained gating networks. The computer-executable instructions, when executed by at least one processor 230 individually or collectively, may cause the electronic device 201 to obtain a plurality of first updated expert models by changing a plurality of parameters of an expert model corresponding to each of the plurality of first trained expert models, respectively, based on the plurality of first trained expert models.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 440) including one or more instructions that are stored in a storage medium (e.g., internal memory 436 or external memory 438) that is readable by a machine (e.g., the electronic device 411). For example, a processor (e.g., the processor 420) of the machine (e.g., the electronic device 411) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Further, the data structure used in the afore-described embodiments of the disclosure may be recorded on a computer-readable recording medium through various means. The computer-readable recording medium includes storage media such as magnetic storage media (e.g., ROM, floppy disk, hard disk, and so on) and optical recording media (e.g., CD-ROM, DVD, and so on).

The disclosure has been described above with reference to example embodiments thereof. Those skilled in the art will understand that the disclosure may be implemented in modified forms without departing from the essential characteristics thereof. Therefore, the disclosed embodiments should be considered in an illustrative sense rather than a restrictive sense. The scope of the disclosure is defined by the appended claims rather than the foregoing description, and all differences within the scope equivalent thereto should be construed as being included in the disclosure.

What is claimed is:

1. An electronic device comprising:
communication circuitry;
at least one processor comprising processing circuitry; and
memory storing instructions that, when executed by the at least one processor individually or collectively, cause the electronic device to:
identify a plurality of expert models corresponding to a plurality of external electronic devices configured to perform federated learning, wherein the plurality of expert models are included in a large language model (LLM), and wherein the LLM includes a gating network pre-trained to identify at least one expert model, corresponding to input data, among the plurality of expert models, and
transmit, to the plurality of external electronic devices, through the communication circuitry, the gating network and each of the plurality of expert models, for training the gating network and the each of the plurality of expert models.

2. The electronic device of claim 1, wherein the plurality of expert models comprises a plurality of parameters,
wherein a number of the plurality of parameters of each of the plurality of expert models is less than a number of a plurality of parameters of the large language model,
wherein the gating network is trained to identify, based on the input data, the at least one expert model, to which the input data is input, among the plurality of expert models, and
wherein the instructions, when executed by the at least one processor individually or collectively, cause the electronic device to:
receive, from the plurality of external electronic devices, through the communication circuitry, a plurality of first trained gating networks and a plurality of first trained expert models,
obtain a first updated gating network by changing a plurality of parameters of the gating network, based on the plurality of first trained gating networks,, and
obtain a plurality of first updated expert models by changing a plurality of parameters of an expert model corresponding to the plurality of first trained expert models, based on the plurality of first trained expert models.

3. The electronic device of claim 2, wherein the plurality of first trained gating networks comprises a plurality of parameters changed based on the plurality of parameters of the gating network and first training data of the corresponding external electronic device,
wherein the plurality of first trained expert models comprise a plurality of parameters changed based on the plurality of parameters of the expert model corresponding to the corresponding external electronic device and the first training data of the corresponding external electronic device, and
wherein the first training data of the corresponding external electronic device includes user data obtained by the corresponding external electronic device.

4. The electronic device of claim 3, wherein the instructions, when executed by the at least one processor individually or collectively, cause the electronic device to:
identify a plurality of first updated expert models corresponding to the plurality of external electronic devices, in the large language model, wherein the large language model comprises the first updated gating network and the plurality of first updated expert models, and
transmit, to the plurality of external electronic devices, through the communication circuitry, the first updated gating network and updated expert model corresponding to an external electronic device among the plurality of expert models.

5. The electronic device of claim 4, wherein the instructions, when executed by the at least one processor individually or collectively, cause the electronic device to:
identify, based on a linear sum assignment method, the plurality of first updated expert models of the LLM corresponding to the plurality of external electronic devices.

6. The electronic device of claim 5, wherein the instructions, when executed by the at least one processor individually or collectively, cause the electronic device to:
receive, from the plurality of external electronic devices, through the communication circuitry, a plurality of second trained gating network and a plurality of second trained expert models,
obtain a second updated gating network by changing a plurality of parameters of the first updated gating network, based on the plurality of second trained gating networks,
obtain a plurality of second updated expert models by changing a plurality of parameters of an updated expert model corresponding to the plurality of second trained expert models, based on the plurality of second trained expert models, and
transmit, to the plurality of external electronic devices, through the communication circuitry, a second updated expert model corresponding to the second updated gating network and a corresponding external electronic device.

7. The electronic device of claim 6, wherein each of the plurality of second trained gating networks comprises a plurality of parameters changed based on the plurality of parameters of the first updated gating network and second training data of the corresponding external electronic device,
wherein each of the plurality of second trained expert models comprises a plurality of parameters changed based on the plurality of parameters of the first updated expert model corresponding to the corresponding external electronic device and the second training data of the corresponding external electronic device, and
wherein the second training data of the corresponding external electronic device comprises user data obtained by the corresponding external electronic device.

8. The electronic device claim 7, wherein the LLM comprises a plurality of transformer blocks,
wherein each of the plurality of transformer blocks comprises the gating network and the plurality of expert models, and
wherein each of the plurality of expert models comprises a plurality of parameters obtained based on low-rank adaptation among a plurality of parameters of the LLM.

9. The electronic device claim 8, wherein the large language model comprises a text input estimation model trained to estimate text information to be sequentially input based on input text information, and
wherein the text input estimation model is trained based on training data comprising information associated with a typing pattern, a language usage pattern, and communication preference of a user.

10. A method of performing federated learning by an electronic device, the method comprising:
identifying a plurality of expert models corresponding to a plurality of external electronic devices configured to perform federated learning, wherein the plurality of expert models are included in a large language model (LLM), and wherein the LLM includes a gating network pre-trained to identify at least one expert model, corresponding to input data, among the plurality of expert models, and
transmitting, to the plurality of external electronic devices, through the communication circuitry of the electronic device, the gating network and each of the plurality of expert models, for training the gating network and the each of the plurality of expert models.

11. The method of claim 10, wherein each of the plurality of expert models comprises a plurality of parameters,
wherein a number of the plurality of parameters of each of the plurality of expert models is less than a number of a plurality of parameters of the large language model,
wherein the gating network is trained to identify, in response to input data, at least one expert model, to which the input data is input, among the plurality of expert models, and
wherein the method further comprises:
receiving, from the plurality of external electronic devices, a plurality of first trained gating networks and a plurality of first trained expert models;
obtaining a first updated gating network by changing a plurality of parameters of the gating network, based on the plurality of first trained gating networks; and
obtaining a plurality of first updated expert models by changing a plurality of parameters of an expert model corresponding to the plurality of first trained expert models, based on the plurality of first trained expert models.

12. The method of claim 11, wherein each of the plurality of first trained gating networks comprises a plurality of parameters changed based on the plurality of parameters of the gating network and first training data of the corresponding external electronic device,
wherein each of the plurality of first trained expert models comprises a plurality of parameters changed based on the plurality of parameters of the expert model corresponding to the corresponding external electronic device and the first training data of the corresponding external electronic device, and
wherein the first training data of the corresponding external electronic device comprises user data obtained by the corresponding external electronic device.

13. The method of claim 12, further comprising:
identifying a plurality of first updated expert models corresponding to the plurality of external electronic devices, in the large language model, wherein the large language model comprises the first updated gating network and the plurality of first updated expert models; and
transmitting, to each of the plurality of external electronic devices, a first updated expert model corresponding to the first updated gating network and the corresponding external electronic device.

14. The method of claim 13, wherein the identifying the plurality of first updated expert models corresponding to the plurality of external electronic devices, in the large language model comprises identifying, based on a linear sum assignment method, the plurality of first updated expert models of the large language model corresponding to the plurality of external electronic devices.

15. The method of claim 14, further comprising:
receiving, from the plurality of external electronic devices, a plurality of second trained gating networks and a plurality of second trained expert models;
obtaining a second updated gating network by changing a plurality of parameters of the first updated gating network, based on the plurality of second trained gating networks;
obtaining a plurality of second updated expert models by changing a plurality of parameters of the first updated expert model corresponding to the plurality of second trained expert models, based on the plurality of second trained expert models; and
transmitting, to each of the plurality of external electronic devices, a second updated expert model corresponding to the second updated gating network and a corresponding external electronic device.

16. The method of claim 15, wherein each of the plurality of second trained gating networks comprises a plurality of parameters changed based on the plurality of parameters of the first updated gating network and second training data of the corresponding external electronic device,
wherein each of the plurality of second trained expert models comprises a plurality of parameters changed based on the plurality of parameters of the first updated expert model corresponding to the corresponding external electronic device and the second training data of the corresponding external electronic device, and
wherein the second training data of the corresponding external electronic device comprises user data obtained by the corresponding external electronic device.

17. The method of claim 16, wherein the large language model comprises a plurality of transformer blocks,
wherein each of the plurality of transformer blocks comprises the gating network and the plurality of expert models, and
wherein each of the plurality of expert models comprises a plurality of parameters obtained based on low-rank adaptation among a plurality of parameters of the large language model.

18. The method of claim 17, wherein the large language model comprises a text input estimation model trained to estimate text information to be sequentially input based on input text information, and
wherein the text input estimation model is trained based on training data comprising information associated with a typing pattern, a language usage pattern, and communication preference of a user.

19. A non-transitory computer-readable storage medium storing computer-executable instructions that, when executed by at least one processor individually or collectively, cause an electronic device to:
identify a plurality of expert models corresponding to a plurality of external electronic devices configured to perform federated learning, wherein the plurality of expert models are included in a large language model (LLM), and wherein the LLM includes a gating network pre-trained to identify at least one expert model, corresponding to input data, among the plurality of expert models, and
transmit, to the plurality of external electronic devices, through the communication circuitry, the gating network and each of the plurality of expert models, for training the gating network and the each of the plurality of expert models.

20. The non-transitory computer-readable storage medium of claim 19, wherein each of the plurality of expert models comprises a plurality of parameters,
wherein a number of the plurality of parameters of each of the plurality of expert models is less than a number of a plurality of parameters of the large language model,
wherein the gating network is trained to identify, in response to input data, at least one expert model, to which the input data is input, among the plurality of expert models, and
wherein the computer-executable instructions, when executed by the at least one processor individually or collectively, cause the electronic device to:
receive, from the plurality of external electronic devices, a plurality of first trained gating networks and a plurality of first trained expert models,
obtain a first updated gating network by changing a plurality of parameters of the gating network, based on the plurality of first trained gating networks, and
obtain a plurality of first updated expert models by changing a plurality of parameters of an expert model corresponding to the plurality of first trained expert models, based on the plurality of first trained expert models.
